(19) United States
(12) Patent Application Publication
(10) Pub. No.: US 2002/0184082 A1
(43) Pub. Date: Dec. 5, 2002

(54) Customer satisfaction evaluation method and storage medium that stores evaluation program

(76) Inventors: Takashi Nakano, Yokohama-shi (JP); Kunio Noguchi, Yamato-shi (JP); Yuji Kyoya, Kawasaki-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/157,153

(22) Filed: May 30, 2002

(30) Foreign Application Priority Data
May 31, 2001 (JP) 2001-164693

(51) Int. Cl. G06F 17/60

(52) U.S. Cl. 705/10

(57) ABSTRACT

Customer requirements from a customer are listed in the row direction of a QFD chart. Product characteristics are associated in the column direction of the chart to develop the functions, thereby obtaining QFD data. Using the QFD data, useful information, i.e., customer satisfaction that is useful for evaluating how the customer satisfaction of customer requirements would change in accordance with the achievement value of the product characteristics is obtained from the relationship between the actual achievement value (benchmark value) of the product characteristics and the estimated value of customer satisfaction of the customer requirements.

### CROSS-REFERENCE TO RELATED APPLICATIONS

This application is based upon and claims the benefit of priority from the prior Japanese Patent Application No. 2001-164693, filed May 31, 2001, the entire contents of which are incorporated herein by reference.

### BACKGROUND OF THE INVENTION

1. Field of the Invention

The present invention relates to a method of evaluating customer satisfaction according to the degree of realization of product characteristics, and a recording medium that stores a program for executing the method.

2. Description of the Related Art

As a method of determining product specifications from the aspect of product characteristics while planning or developing a product, quality function development (reference “Quality Development Method (1)”, Nikkagiren Shuppan-Sha) is known. Quality function development is also called QFD. This is a method of grasping and analyzing customer requirements for a product and converting the customer requirements into product characteristics and also into parts characteristics. This QFD is realized by a system using a computer and applied for product planning, calculation of a product quality importance rating, and design support.

In product planning and the like using QFD, operations such as converting a goal with respect to customer requirements into a numerical value, extracting and linking product characteristics related to the customer requirements, and converting the product characteristics into a numerical value are done by QFD executers (persons who are engaging in product planning and the like) using a QFD chart.

In the conventional product planning and development using QFD, any method of quantitatively evaluating how the reaction (satisfaction) from a customer would change in accordance with the degree of realization of product characteristics has not been proposed. As requirements from customers are recently becoming stricter, products with a sufficient customer satisfaction must be provided to markets. For this reason, it is necessary to obtain information to effectively evaluate a target product in advance at the early stage such as product planning and development (upstream process) and to progress planning and development using the product evaluation information, thereby reducing risk in putting the product onto the market.

### BRIEF SUMMARY OF THE INVENTION

Accordingly, the present invention aims to provide a method of obtaining information such as a customer satisfaction index to effectively evaluate a product and a recording medium storing a program for executing the method.

According to an embodiment of the present invention, a customer satisfaction evaluation method comprises obtaining data relating to a goal of customer requirements, a degree of association between the customer requirements and product characteristics, a baseline of the product characteristics, a target of the product characteristics based on a quality function development chart for converting the customer requirements to the product characteristics; obtaining a relationship between the baseline of the product characteristics and the target of the product characteristics and a relationship between the goal of the customer requirements and a customer satisfaction of the customer requirements; and obtaining a customer satisfaction of the customer requirements corresponding to an actual achievement value of the product characteristics.

According to an embodiment of the present invention, an article of manufacture comprising a computer usable medium having computer readable program code means for evaluating a customer satisfaction embodied therein, the computer readable program code means comprises computer readable program code means for causing a computer to obtaining data relating to a goal of customer requirements, a degree of association between the customer requirements and product characteristics, a baseline of the product characteristics, a target of the product characteristics based on a quality function development chart for converting the customer requirements to the product characteristics; computer readable program code means for causing a computer to obtain a relationship between the baseline of the product characteristics and the target of the product characteristics and a relationship between the goal of the customer requirements and a customer satisfaction of the customer requirements; and computer readable program code means for causing a computer to obtain a customer satisfaction of the customer requirements corresponding to an actual achievement value of the product characteristics.

### BRIEF DESCRIPTION OF THE SEVERAL VIEWS OF THE DRAWING

FIG. 1 is a block diagram showing the hardware configuration of a computer system which outputs information useful for evaluation of customer satisfaction using QFD, according to an embodiment of the present invention;

FIGS. 2A, 2B, 2C, and 2D are a view showing a QFD chart, and FIG. 2E shows the manner in which FIGS. 2A, 2B, 2C, and 2D are combined;

FIG. 3 is a flow chart showing the basic procedure of QFD;

FIGS. 4A, 4B, 4C, and 4D are a view showing a detailed example of QFD, and FIG. 4E shows the manner in which FIGS. 4A, 4B, 4C, and 4D are combined;

FIG. 5 is a graph showing the relationship between the product characteristics and the satisfaction index when the direction of improvement of the product characteristics is a maximizing direction;

FIG. 6 is a graph showing the relationship between the product characteristics and the satisfaction index when the direction of improvement of the product characteristics is a minimizing direction;

FIG. 7 is a graph showing the relationship between the product characteristics and the satisfaction index when the direction of improvement of the product characteristics is directed to a target value;

FIG. 8 is a table showing a satisfaction index of each item of the product characteristics related to a customer requirement “Is comfortable to ride in”;

FIG. 9 is a table showing examples of customer requirement achievement values for the detailed example shown in FIGS. 4A to 4D; and

FIG. 10 is a table showing calculation results of customer attitude ratings.

### DETAILED DESCRIPTION OF THE INVENTION

A QFD support method and storage medium according to an embodiment of the present invention will be described below with reference to the accompanying drawing.

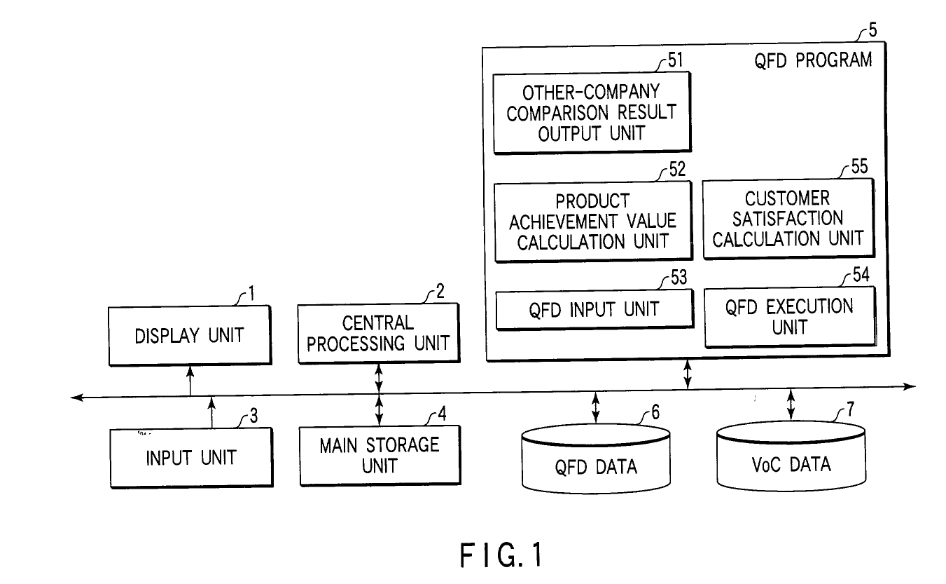

FIG. 1 is a block diagram showing the hardware configuration of a computer system that realizes the QFD support method according to the first embodiment of the present invention. This system has a display unit 1, central processing unit (CPU) 2, input unit 3, and main storage unit 4. A QFD program 5 shown in FIG. 1 creates and edits data (spreadsheet data) 6 of a QFD chart, which is applied to product planning, calculation of importance of product characteristics, and design support, and realizes various kinds of information processing of generating customer satisfaction evaluation information. This program is loaded to the main storage unit 4 and executed by the central processing unit 2. When the program 5 is executed, a QFD chart is displayed on the display unit 1, an item (also called a cell) on the chart is selected through the input unit 3 such as a keyboard or mouse, and characters or numerical values are input under the control of the central processing unit 2. The system of this embodiment also has a function of referring to VoC (Voice of Customer) data 7 at the time of QFD operation. The data structure and reference of the VoC data 7 will be described later.

The operation function of the QFD program 5 comprises an other-company comparison result output unit 51, product achievement value calculation unit 52, QFD input unit 53, customer satisfaction calculation unit 55, and QFD execution unit 54. The QFD input unit 53 receives user's input operation to the QFD chart. The QFD execution unit 54 generates the QFD data 6 (to be described next) on the basis of data input by the user through the QFD input unit 53.

The system of this embodiment is a system for executing QFD. Customer satisfaction calculation and the like according to the present invention can be done using the QFD data 6 that has already been generated. Hence, the already generated QFD data 6 may be read out from a file or the like without using the QFD input unit 53 and QFD execution unit 54.

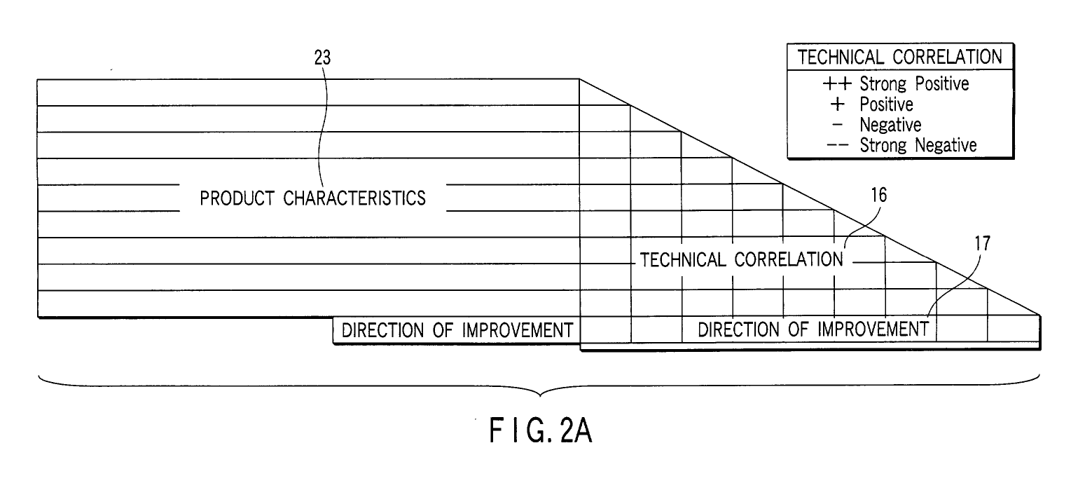

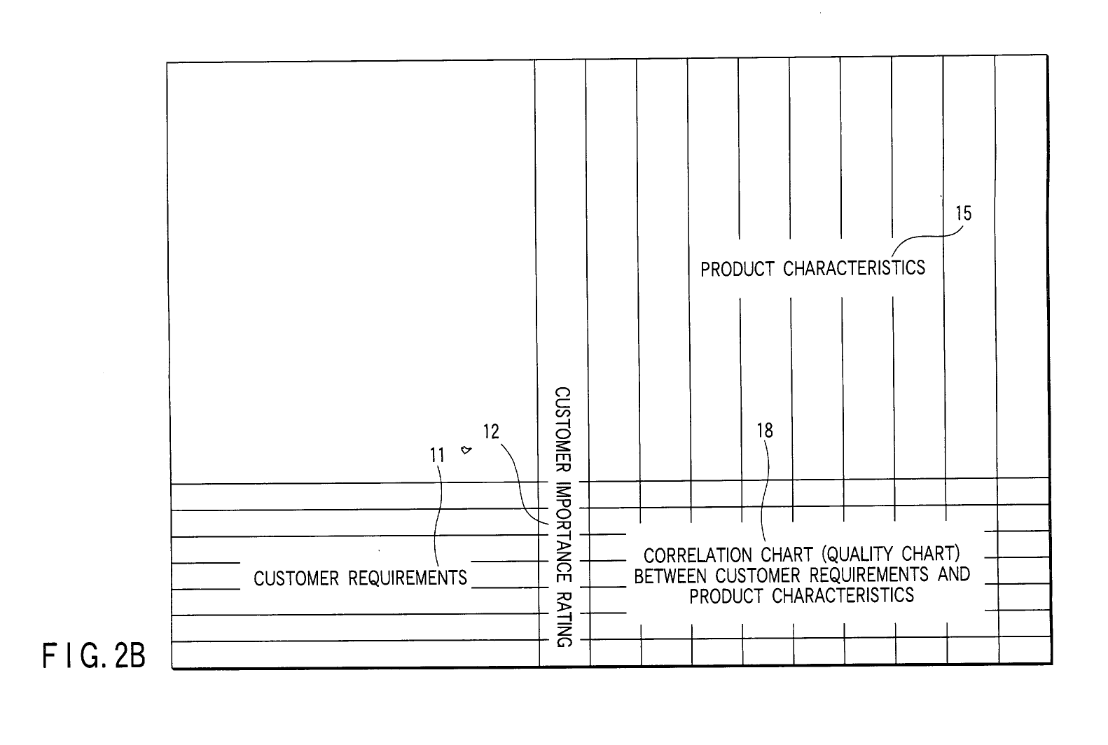

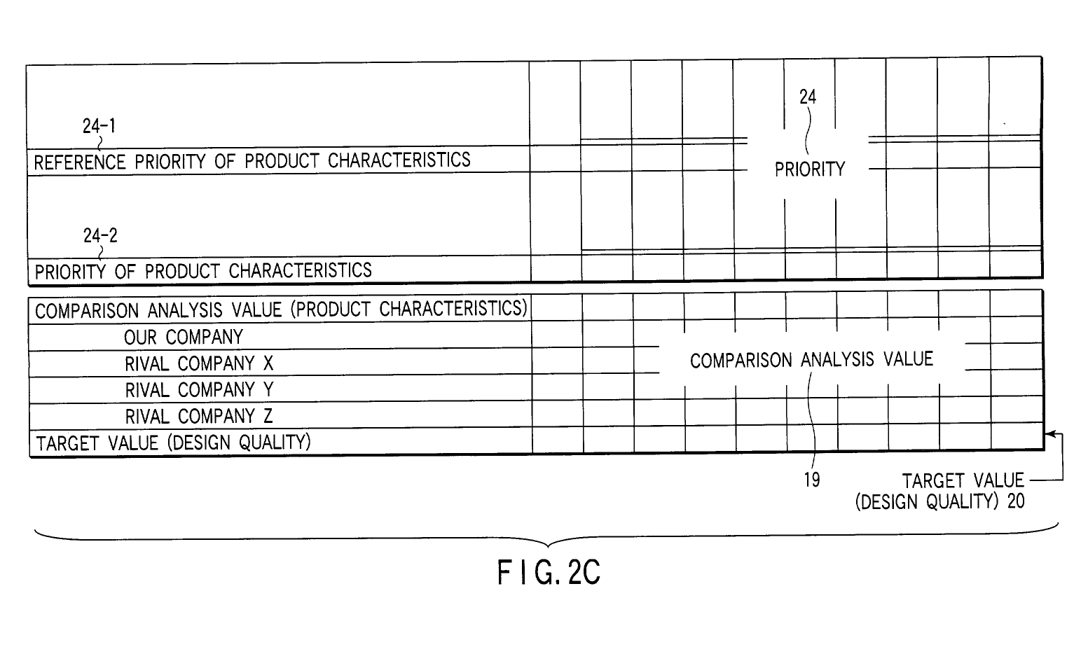

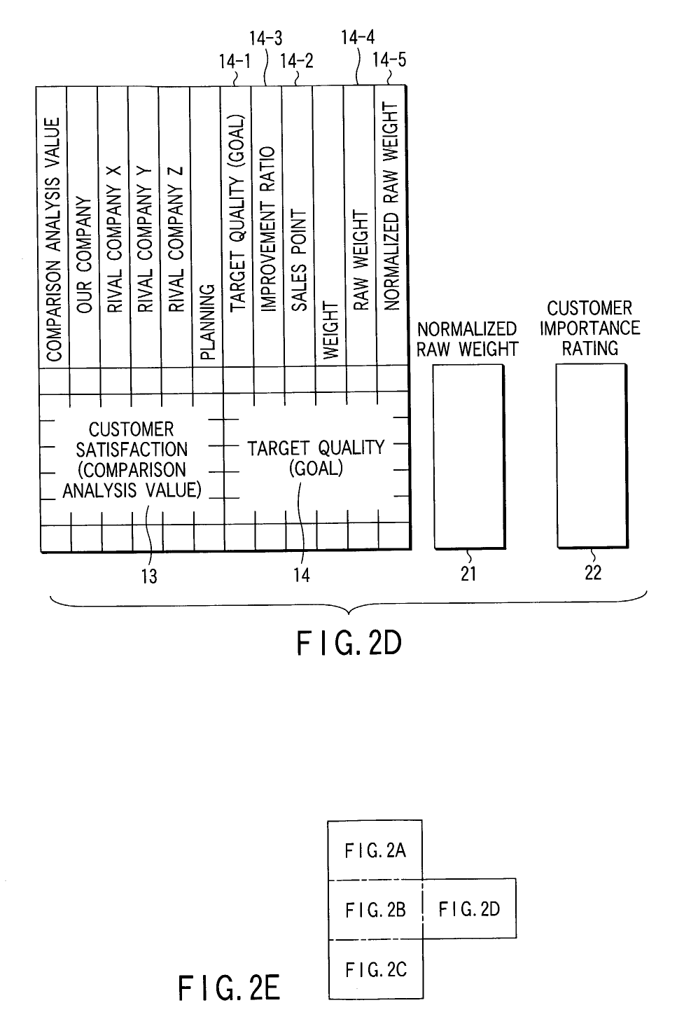

FIGS. 2A, 2B, 2C, and 2D are a view showing a QFD chart applied to the system of the present invention. This QFD chart is created from electronic spreadsheet data and used as the template of the QFD data 6. As shown in FIGS. 2A to 2D, the QFD chart is created from a plurality of table items and, more specifically, customer requirements 11, a customer importance rating 12, customer satisfaction (also called comparison analysis value) 13, target quality (goal) 14, normalized raw weight 21, customer importance rating 22, product characteristics 15 and 23, technical correlation 16, direction of improvement 17, customer requirements vs. product characteristics correlation chart (quality chart) 18, priority 24, comparison analysis value (benchmark value) 19 of the product characteristics, and target (design quality) 20. Obtaining the priorities 24 of each item of the product characteristics from the customer requirement importance ratings 12 of each item of the customer requirements 11 is called “development”.

Using such a QFD chart, items of the customer requirements 11 from the customer are listed in the row direction (vertical direction) of the QFD chart, and items of the functions are developed in the column direction (horizontal direction: product characteristics) of the chart. This QFD will be referred to as QFD-I here. Operations of grasping and analyzing customer requirements from a customer for a product or service and converting the customer requirements into the product characteristics are done in this QFD-I.

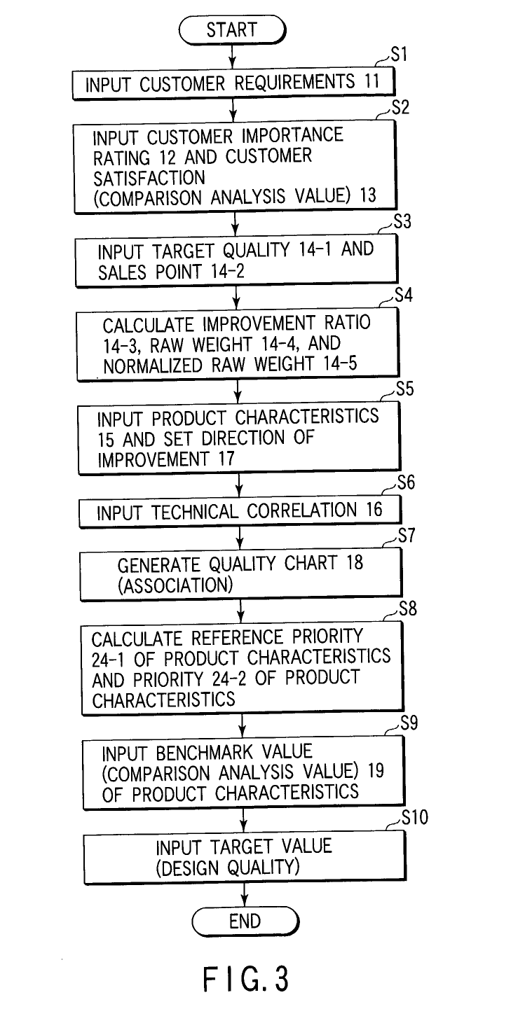

FIG. 3 is a flow chart showing the basic procedure of QFD-I. A QFD executer inputs or edits data on the QFD chart shown in FIGS. 2A to 2D in accordance with the basic procedure shown in FIG. 3. The basic procedure of QFD-I is formed from inputting the customer requirements 11 (step S1), inputting the customer requirement importance rating 12 and the customer satisfaction (comparison analysis value) 13 (step S2), inputting the target quality 14 (step S3) (inputting the target quality includes inputting a target quality 14-1 in the narrow sense and also inputting a sales point 14-2), calculating an improvement ratio 14-3, raw weight 14-4, and normalized raw weight 14-5 (step S4), inputting the product characteristics 15 and setting the direction of improvement 17 (step S5), inputting the technical correlation 16 (step S6), associating the customer requirements with product characteristics (creating the quality chart 18) (step S7), calculating the priority 24 (a reference priority 24-1 of product characteristics and priority 24-2 of product characteristics) (step S8), inputting the comparison analysis value (benchmark value) 19 of product characteristics (step S9), and determining (inputting) the target value (design quality) 20 (step S10). In calculation steps S4 and S8, when necessary data is given, the computer system of this embodiment automatically calculates the values and fills the QFD chart with them. Steps S9 and S10 may be omitted. If the reference priority 24-1 of product characteristics and priority 24-2 of product characteristics seem to be inappropriate, the flow returns to step S5 or S7 to add or delete product characteristic or re-inputting the technical correlation.

The basic procedure of QFD-I will be described below on the basis of a detailed example.

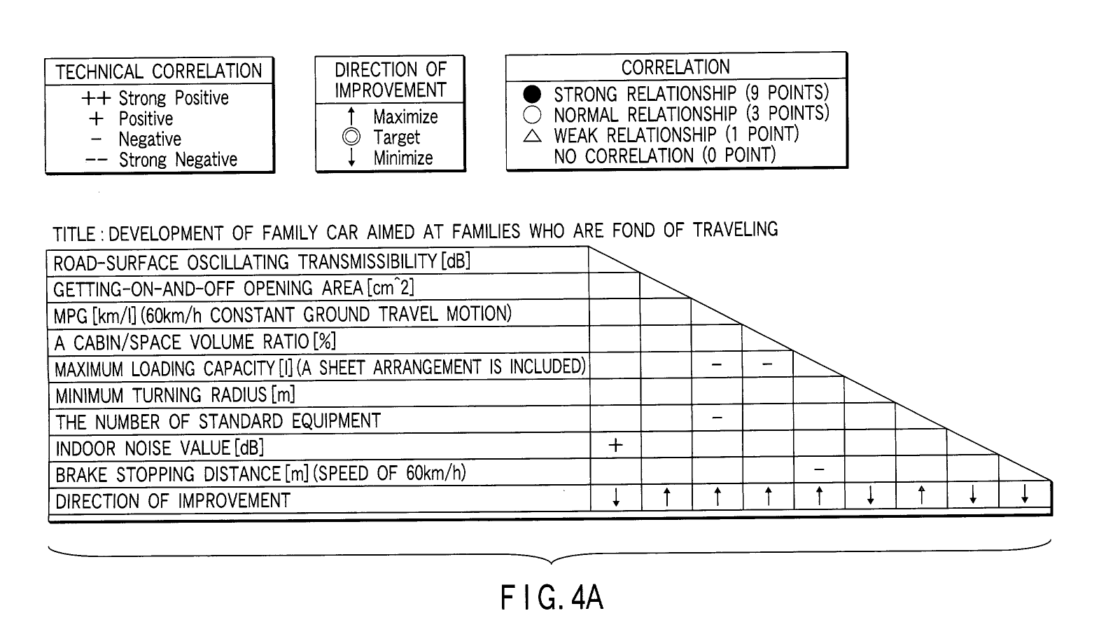

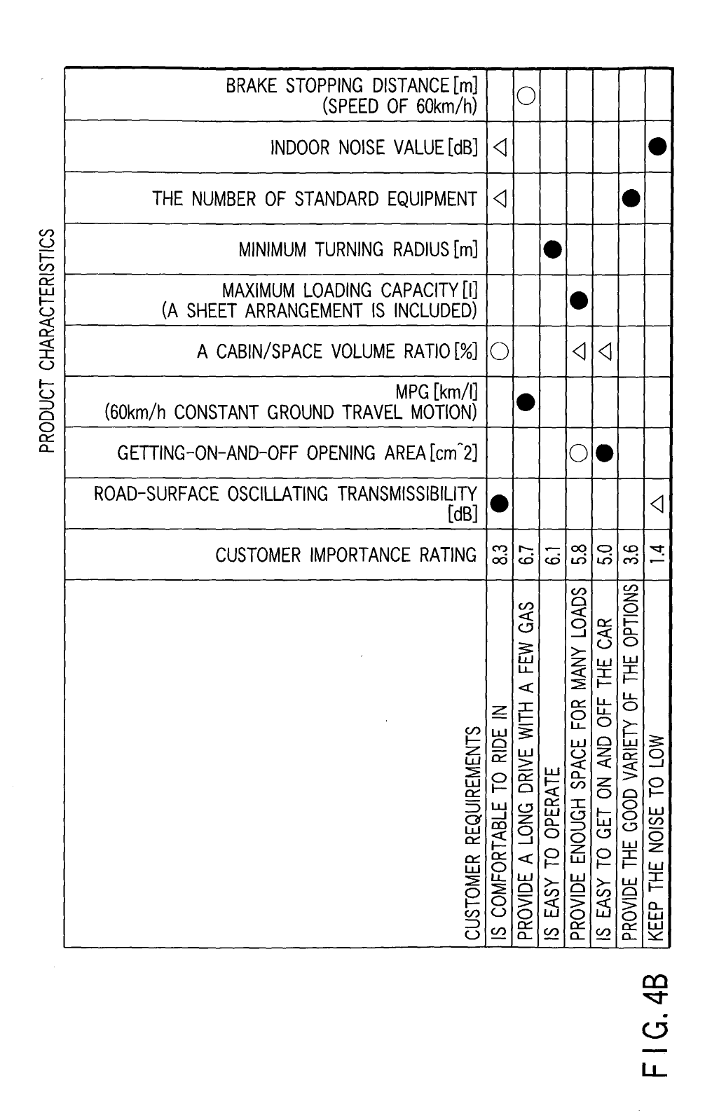

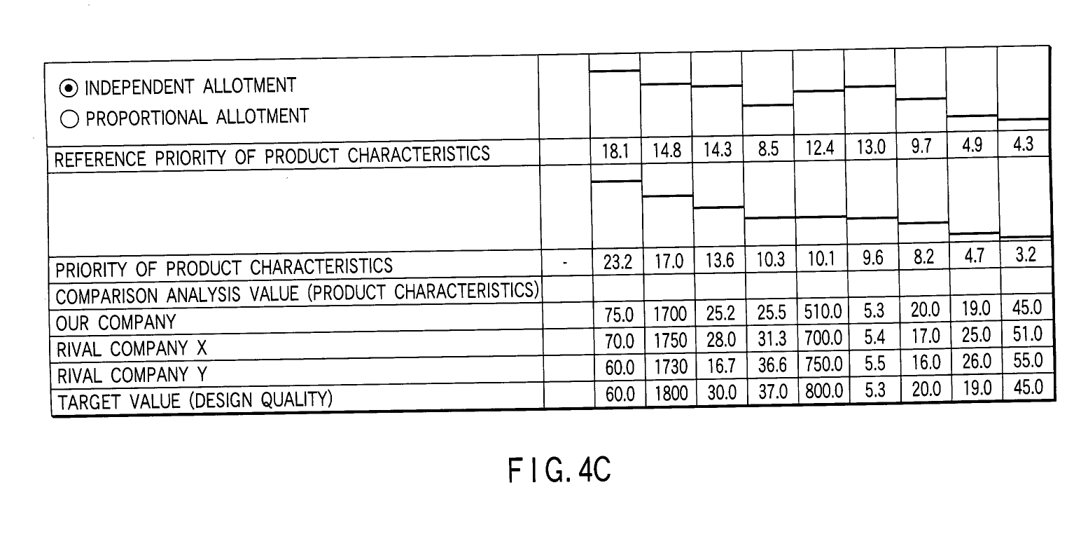

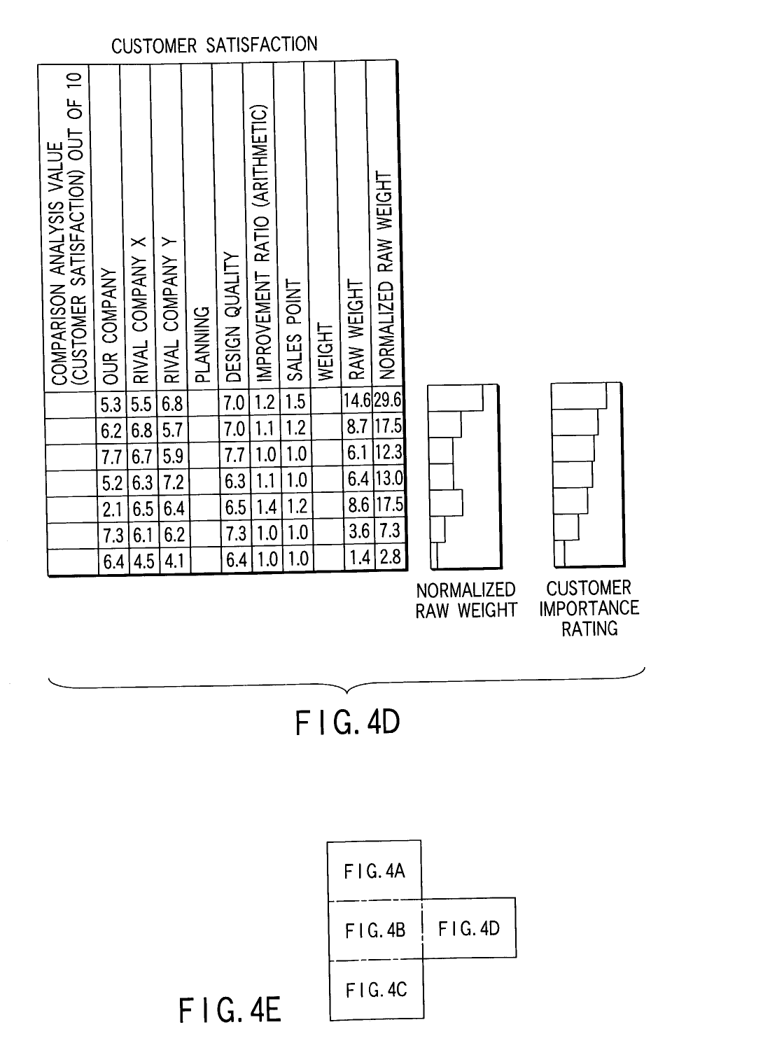

FIGS. 4A, 4B, 4C, and 4D show QFD-I in “merchandise planning of family car aimed at families who are fond of traveling”. In this QFD-I, first, the QFD executer is caused to input requirement items to the field of the customer requirements 11. In this case, e.g., items “Is comfortable to ride in”, “Provide a long drive with a few gas”, “Is easy to operate”, and the like are input based on customer's requests (step S1 in FIG. 3). Instead of manually inputting the requirement items by the QFD executer, they may be automatically extracted and input based on VoC (Voice of Customer) data 7 (to be described later).

Next, for each of the customer importance ratings, a relative value of the rating to the maximum value “10” is input to the field of customer requirement importance rating 12 on the QFD chart based on a questionnaire result obtained in advance. Here, customer requirement importance rating “8.3” is input for, e.g., customer requirement “Is comfortable to ride in”. In a similar manner, customer requirement importance rating “6.7” is input for, e.g., customer requirement “Provide a long drive with a few gas”. In addition, for each of the customer requirements 11, a customer requirement importance rating is input to the field of customer satisfaction 13. In this case, the degree of customer satisfaction is input as 10-grade evaluation value according to questionnaire results obtained in advance about our company and other companies (e.g., rival companies X, Y, and Z) at the current time (step S2).

Next, the QFD executer is caused to set and input the target of the degree of customer satisfaction for the next coming planned product (here, a family car) to the field of target quality 14-1 in the narrow sense as 10-grade evaluation value. In addition, the QFD executer is caused to select the degree of appeal of the new product or service (sales point) 14-2 from three values, e.g., 1.0 (current level should be maintained), 1.2 (certain sales point), and 1.5 (important sales point) and input the value (step S3).

When the customer satisfaction 13 and sales point 14-2 are input, the improvement ratio 14-3 representing the degree of necessary improvement of the target quality with respect to the current satisfaction is automatically calculated. This improvement ratio is calculated by, e.g.,

Improvement ratio=1+0.1×(target quality−customer satisfaction for our company)

Referring to FIGS. 4A to 4D for, e.g., the item “Is comfortable to ride in” in the customer requirements 11, the customer satisfaction 13 for our company is 5.3, and the target quality 14 is 7.0. As the value of the improvement ratio 14-3 calculated in accordance with the above formula, 1.17 is rounded to 1.2. In addition, the raw weight 14-4, i.e., an evaluation value calculated from the product of the customer requirement importance rating 12, improvement ratio 14-3, and sales point 14-2 is automatically calculated. For, e.g., the customer requirement “Is comfortable to ride in”, the customer requirement importance rating 12 is 8.333 . . . (=8.3), the improvement ratio 14-3 is 1.17 (=1.2), and the sales point 14-2 is 1.5. Hence, a value “114.6” is obtained as the raw weight 14-4 by calculation. Furthermore, as a percentage in the total raw weight (100%), a weight coefficient “29.6” of the raw weight 14-4 of the customer requirements is automatically calculated as the normalized raw weight 14-5 (step S4).

Next, operation of converting the customer requirements 11 into the product characteristics 15 as a technical matter of the product is performed. First, the QFD executer is caused to extract the product characteristics, which are necessary for acquiring the customer satisfaction 13 (comparison analysis value) of the customer requirements 11, and input them to the fields of product characteristics 15. In addition, the QFD executer is caused to set and input the direction of increase/decrease in the improvement of each of product characteristics to the field of the direction of improvement 17 (step S5). As the direction of improvement 17, the QFD executer is caused to set and input one of a direction in which the product characteristic is maximized, a direction in which the product characteristic is minimized, and a direction in which the product characteristic is made close to a specific target. As shown in FIGS. 4A to 4D, these directions of improvement are indicated by, e.g., an up arrow (↑), down arrow (⇓), and double circle (⊚) on the QFD chart.

The plurality of extracted product characteristics have such correlations that when the performance of one product characteristic is improved, that of another product characteristic degrades (strong negative), or as the performance of one product characteristic is improved, that of another product characteristic is also improved (strong positive). Such correlations are input to the field of the technical correlation 16 on the QFD chart (step S6). As shown in FIGS. 4A to 4D, these correlations are indicated by, e.g., “−−”, “−”, “+”, and “++” on the QFD chart.

Next, the QFD executer is caused to associate the customer requirements 11 with the product characteristics 15 to create the quality chart 18 and select each degree of association from predetermined points (step S7). For example, a high degree of association is marked with ● (association level is 9), a normal degree of association is marked with ◯ (association level is 3), and a low degree of association is marked with Δ (association level is 1). These degrees of association are indicated on the QFD chart 18. According to FIGS. 4A to 4D, for example, a customer requirement “Is comfortable to ride in” is most associated with a product characteristic “Road-surface oscillating transmissibility [dB]”, for which the highest degree of association (●: association level is 9) is set by the QFD executer. This customer requirement is also associated with a product characteristic “A cabin/space volume ratio [%]” as a normal degree of association (◯: association level is 3).

The reference priority 24-1 of product characteristics and priority 24-2 of product characteristics are automatically calculated from the quality chart 18 formed by associating, the customer requirement importance rating 12, and the normalized raw weight value 21 (step S8). The reference priority 24-1 of product characteristics can be obtained by, e.g.,

Reference priority of product characteristics=Σ{customer requirement importance rating×association level between product characteristics and customer requirement importance rating} (1)

wherein Σ is the sum of all customer requirements for each of product characteristics. Note that the reference priority of product characteristics is represented by a percentage with respect to all the product characteristics.

The priority 24-2 of product characteristics is obtained by replacing the customer requirement importance rating 12 in equation (1) with the normalized raw weight 14-5.

Each of the reference priorities 24-1 of product characteristics can be regarded as a value calculated based on the customer importance, and each of the priorities 24-2 of product characteristics can be regarded as a value obtained in consideration of the product strategy (product planning policy) of our company as well as the customer importance. With this calculation, the reference priority 24-1 of product characteristic of “Road-surface oscillating transmissibility [dB]” is calculated as 18.1.

Next, the QFD executer is caused to input the comparison analysis value 19 of product characteristics.

The comparison analysis value 19 is the actually measured value of the product characteristics of the products of our company and other companies. The products can also be benchmarked using the values (step S9). Finally, the QFD executer is caused to input the target value (design quality) of each of the product characteristics of the product to be newly developed to the field of target value 20. These values are the target specifications of the final product (step S10).

This embodiment seems as if the QFD procedure that is used to determine product specifications from the aspect of product characteristics is traced in a reverse direction and outputs the estimated value of customer satisfaction of the customer requirements for an actual achievement value of product characteristics (customer satisfaction calculation unit 55). In addition, the index (customer attitude rating (to be described later)) of the achievement value of the product is output from the estimated value of customer satisfaction of the customer requirements (product achievement value calculation unit 52). Furthermore, for the customer requirements, customer satisfaction of other companies and the estimated value of the customer satisfaction can also be compared and output (other-company comparison result output unit 51). A method of calculating the estimated value of customer satisfaction of the customer requirements for an actual achievement value of product characteristics, using the QFD data 6, will be described below in detail.

An example will be described here, in which the customer satisfaction 13 of the baseline of customer requirements, the target quality 14, the baseline (benchmark) value 19 of the product characteristics, and the target value 20 are referred to from the QFD data 6, and the estimated value of customer satisfaction of the customer requirements corresponding to the actual achievement value of the product characteristics is calculated and output.

The “actual achievement value of product characteristics” means not the target value but the actual product characteristics. The “estimated value of customer satisfaction” means the estimated value of customer satisfaction corresponding to the actual achievement value of the product characteristics.

The directions of improvement of the product characteristics set on the QFD chart are classified into the following types.

First, a case wherein the direction of improvement of product characteristics is “maximize (indicated by an up arrow on the QFD chart)” will be described.

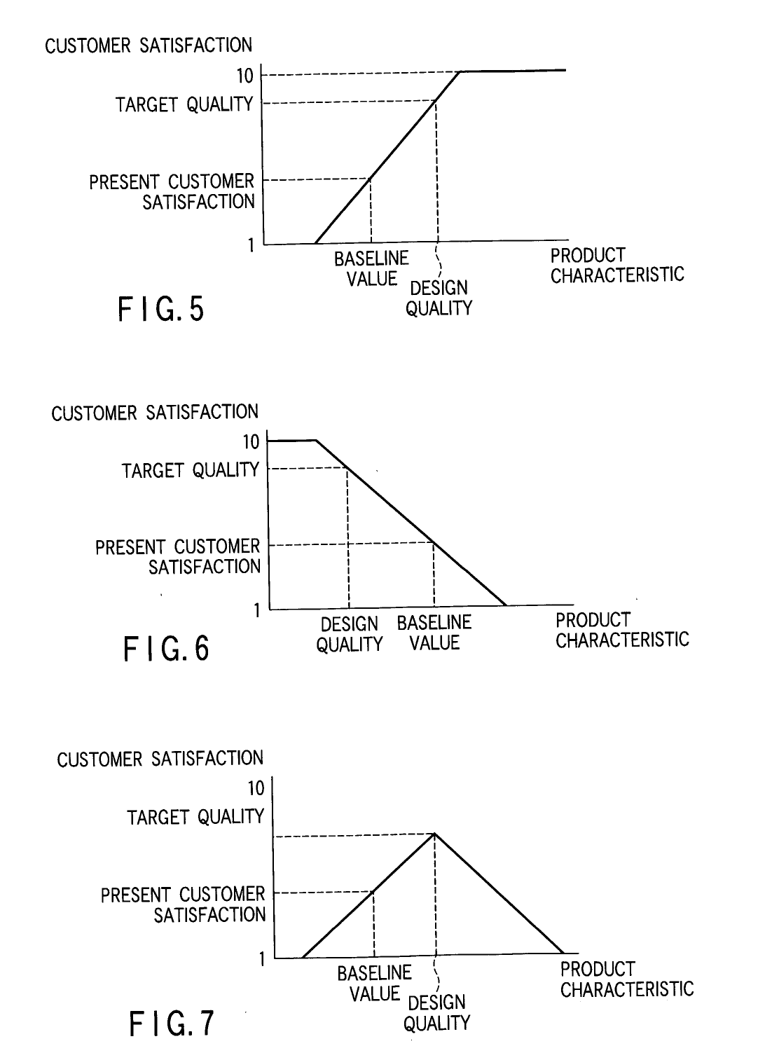

Assume that the customer satisfaction for our company of the baseline of customer requirements is obtained when the product characteristics of our company have the baseline value, and the design quality is obtained when the product characteristics have the design quality. In this case, the actual achievement value of product characteristics and the estimated value of customer satisfaction have a relationship shown in FIG. 5. As is apparent from FIG. 5, the following linear equation is derived.

That is, when the actual achievement value of product characteristics is defined as EMx, the estimated value of customer satisfaction is given by

Estimated value of customer satisfaction=(design quality−present customer satisfaction (i.e., customer satisfaction for our company))/(design quality−baseline value (i.e., product characteristics of our company))EMx+(design quality×present customer satisfaction−baseline value×design quality)/(design quality−baseline value)

The customer satisfaction ranges from 1 to 10 (when the customer satisfaction is equal to or less than 1, the customer satisfaction is 1; when the customer satisfaction is equal to or more than 10, the customer satisfaction is 10).

When the design quality equals the baseline value, the above formula may be rewritten by replacing the customer satisfaction and product characteristics of a rival company with those of our company. The same calculation method as described above can be used even when the design quality equals the present customer satisfaction. If data of any other rival company cannot be used, and no formula can be written, it is assumed that the customer satisfaction is constant, and the design quality is directly employed as the estimated value of customer satisfaction. In this case, even when the actual achievement value of the product characteristics has changed, it is not reflected in the estimated value of customer satisfaction.

In QFD of development of a family car shown in FIGS. 4A to 4D, for example, an actual achievement value EMx of product characteristic “Mpg [km/l] (60 km/h constant ground travel motion)” and the estimated value of customer satisfaction of the customer requirement “Provide a long drive with a few gas” have the following relationship.

Estimated value of customer satisfaction=((7.0−6.2)/(30.0−25.2))EMx+((30.0×6.2)−(25.2×7.0))/(30.0−25.5)−EMx/6+2

The customer satisfaction ranges from 1 to 10.

For example, when the actual achievement value of product characteristic “Mpg [km/l] (60 km/h constant ground travel motion)” is 29.0 [km/L], the estimated value of customer satisfaction of the customer requirement “Provide a long drive with a few gas” can be estimated to decrease from 7.0 to 6.8.

Next, a case wherein the direction of improvement of product characteristics is “minimize (indicated by a down arrow on the QFD chart)” will be described.

Like the above-described case of “maximize”, assume that the present customer satisfaction (customer satisfaction for our company) of customer requirements is obtained when the product characteristics have the baseline value, and the design quality is obtained when the product characteristics have the design quality. In this case, the actual achievement value of product characteristics and the estimated value of customer satisfaction have a relationship shown in FIG. 6. As is apparent from FIG. 6, the gradient of the line is reverse to that for “maximize”, and the following linear equation is derived. That is, when the actual achievement value of product characteristics is defined as EMx, as in the case of “maximize”, the estimated value of customer satisfaction is given by

Estimated value of customer satisfaction=(design quality−present customer satisfaction/(design quality−baseline value)EMx+(design quality×present customer satisfaction−baseline value×design quality)/(design quality−baseline value)

The customer satisfaction ranges from 1 to 10 (when the customer satisfaction is equal to or less than 1, the customer satisfaction is 1; when the customer satisfaction is equal to or more than 10, the customer satisfaction is 10).

When the design quality equals the baseline value, or the target quality equals the present customer satisfaction, the same processing as in the case of “maximize” is executed.

In QFD of development of a family car shown in FIGS. 4A to 4D, for example, the actual achievement value EMx of product characteristic “Road-surface oscillating transmissibility [dB]” and the estimated value of customer satisfaction of the customer requirement “Is comfortable to ride in” have the following relationship.

Estimated value of customer satisfaction=((7.0−5.3)/(60.0−75.0))EMx+((60.0×5.3)−(75.0×7.0))/(60.0−75.0)=−(17/150)EMx+69/5

Hence, for example, when the actual achievement value of product characteristic “Road-surface oscillating transmissibility [dB]” is 55.0 [dB], the estimated value of customer satisfaction of the customer requirement “Is comfortable to ride in” can be estimated to increase from 7.0 to 7.6.

Next, a case wherein the direction of improvement of product characteristics is “target (indicated by a double circle (⊚) on the QFD chart)” will be described.

When the direction of improvement is “target”, as is apparent from FIG. 7, a linear equation is generated by the difference (absolute value) between the desired design quality and the actual achievement value of the product characteristics of our company. If the difference between the desired design quality and the actual achievement value of the product characteristics of our company is 0, the actual achievement value of the customer satisfaction is defined as the design quality. If the difference between the desired design quality and the baseline value of the product characteristics of our company is equals to the difference between the estimated value of the customer satisfaction and the design quality, the estimated value of the customer satisfaction is defined as the present customer satisfaction.

When the actual achievement value of product characteristics is defined as EMx, the estimated value of customer satisfaction is given by

Estimated value of customer satisfaction=−((target quality−present customer satisfaction)/(|design quality−baseline value)×design quality−EMx|+target quality

The customer satisfaction ranges from 1 to 10 (when the customer satisfaction is equal to or less than 1, the customer satisfaction is 1; when the customer satisfaction is equal to or more than 10, the customer satisfaction is 10).

When the design quality equals the baseline value, or the target quality equals the present customer satisfaction, the same processing as in the case of “maximize” is executed.

The estimated value of customer satisfaction of the customer requirements is calculated from the actual achievement value of each of the plurality of product characteristics 15 by referring to the QFD chart. The actual achievement value of the product characteristics is entered into the QFD chart in advance. Then, the estimated values of customer satisfaction are synthesized at each ratio (9:3:1) on the basis of the correlation (●, ◯, and Δ) set on the quality chart to calculate the final estimated value of customer satisfaction of the customer requirements. This is given by

Final estimated value of customer satisfaction=Σ{(correlation value to product characteristic i/sum of correlation values for customer requirement)×customer satisfaction at achievement value of product characteristic i}

where i ranges 1 to (the number of product characteristics corresponding to the customer requirements).

A case wherein the final estimated value of customer satisfaction is calculated from the customer requirement “Is comfortable to ride in” in QFD of development of a family car shown in FIGS. 4A to 4D will be described.

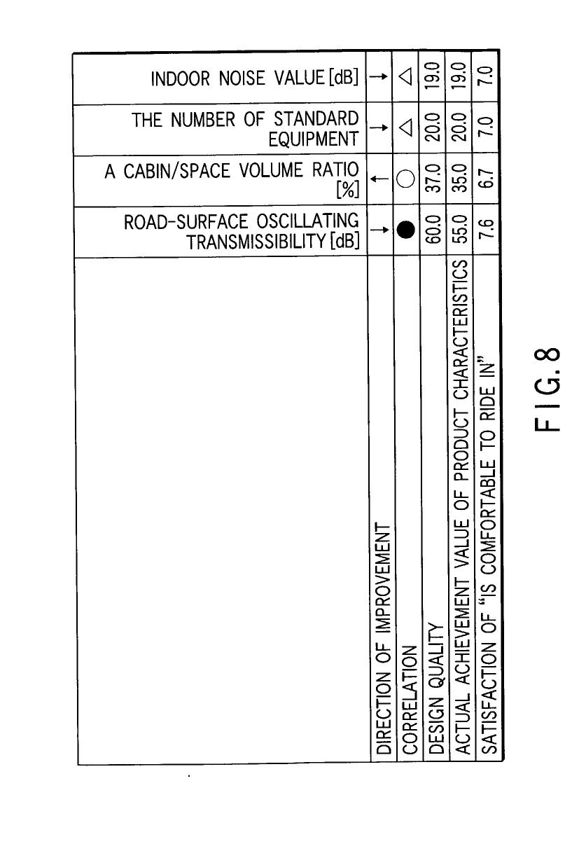

As shown in FIG. 8, as product characteristics related to the customer requirement “Is comfortable to ride in”, “Road-surface oscillating transmissibility [dB]” (9 points), “A cabin/space volume ratio [%] [%]” (3 points), “The number of standard equipment” (1 point), “Indoor noise value [dB]” (1 point) are extracted.

FIG. 8 shows a calculation result of the estimated values of customer satisfaction at the actual achievement value of each of the plurality of product characteristics corresponding to the customer requirements.

The final (comprehensive) estimated value of customer satisfaction of the customer requirement “Is comfortable to ride in” is calculated in the following way by synthesizing the respective estimated values of customer satisfaction by the weight of correlation.

Final estimated value of customer satisfaction=(7.7×9+6.7×3+7.0×1+7.0×1)/(9+3+1+1)=7.3

The estimated value of customer satisfaction related to weak correlation (Δ: 1 point) in the quality chart may be neglected. The final estimated value of customer satisfaction may be calculated only from strong correlation (●: 9 points) and normal correlation (◯: 3 points). In this case, the threshold value is 3 points, and only correlations whose degree is 3 points or more are taken into consideration. Alternatively, the estimated value of customer satisfaction may be calculated only from strong correlation (●: 9 points). In this case, the threshold value is 9 points. If a change in an actual achievement value of product characteristics having weak correlation has no substantial influence on the estimated value of customer satisfaction, emphasis can be put on the strong correlation by excluding the weak correlation. Hence, the accuracy of the value of a change in the estimated value of customer satisfaction can be improved.

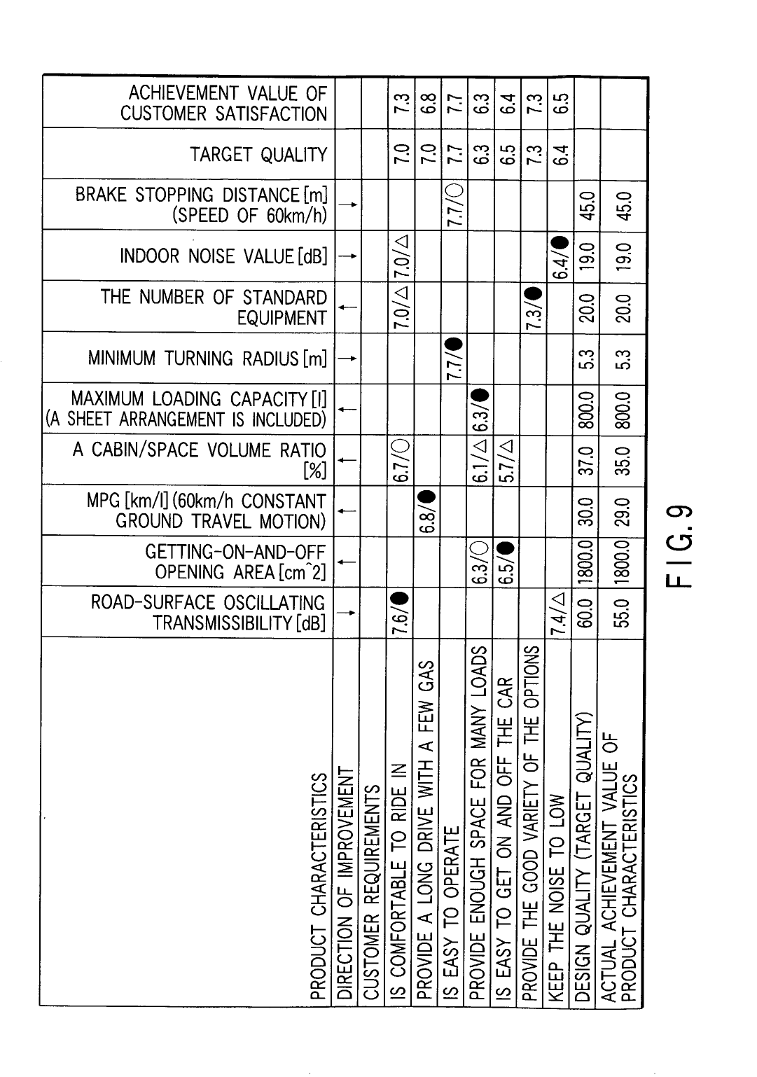

FIG. 9 shows a process of calculating the actual achievement values of customer requirements and the estimated values of customer satisfaction of the customer requirements in the development of a family car shown in FIGS. 4A to 4D. In the example shown in FIG. 9, the actual achievement values of the respective product characteristics are input to the lowermost row. A numerical value at a portion corresponding to customer requirements and product characteristics means the estimated value of customer satisfaction (FIG. 8) of an individual customer requirement when the product characteristic has the achievement value. The final estimated values of customer satisfaction of the customer requirements are synthesized in accordance with the correlation between the customer requirements and the product characteristics and output to the rightmost column.

The final estimated value of customer satisfaction of each of the customer requirements at the actual achievement value of the product characteristics is calculated in the above-described way. Then, in this embodiment, the index of achievement of the product is calculated from the estimated value of customer satisfaction (product achievement value calculation unit 52). As an example of the method of calculating such an index, so-called customer attitude rating is used in this embodiment. A customer attitude rating is an index that indicates the attitude of a customer and the degree of induction of action of the customer. In this embodiment, the customer attitude rating is defined by

Customer attitude rating

$$Customer attitude rating = {\sum }_{i = 1}^{n} ( customer requirement importance rating ) i \times ( customer satisfaction of customer requirement ) i$$

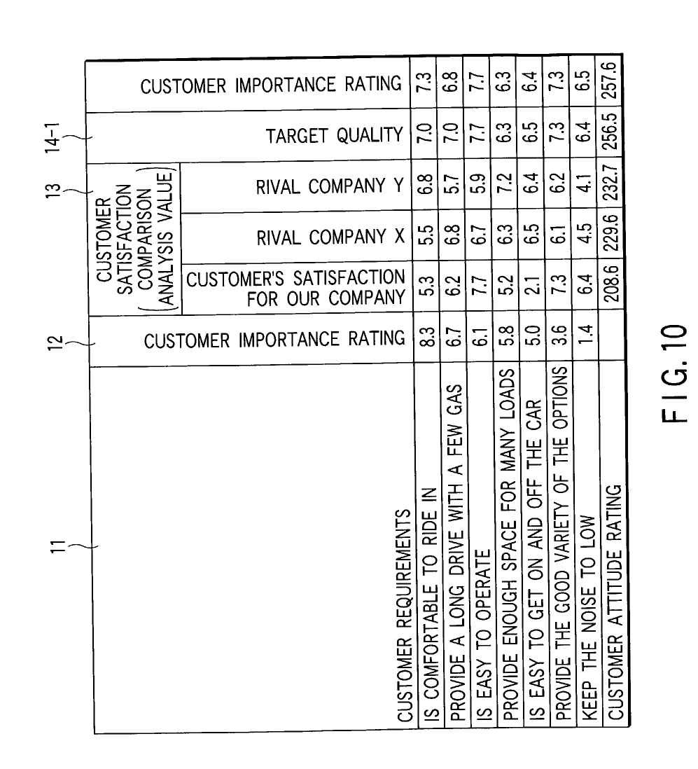

FIG. 10 shows calculation results of customer attitude rating (achievement value of customer satisfaction), baseline customer attitude rating (customer satisfaction for our company), customer attitude rating for rival companies (companies A and B), and target quality customer attitude rating for our company when the product characteristics become the achievement value. In this way, the customer attitude rating when the product characteristics become the achievement value is obtained, and an index indicating how to improve the request from the customer from the baseline can be obtained. Such a calculation result can be effectively plotted on a graph or the like and explicitly indicated to the user as needed. Even when the characteristics of other companies are unknown, the achievement value of the characteristic of our company is converted into customer satisfaction in this way, thereby executing benchmark evaluation on the basis of the customer attitude rating.

As an application example, when the product characteristics can be known although the estimated value of customer satisfaction of another company is unknown, the product characteristics of this company is used as an actual achievement, thereby estimating the value of customer satisfaction in this company.

As described above, according to this embodiment, using QFD data, useful information can be calculated and output to evaluate how the estimated value of customer satisfaction of customer requirements would change in accordance with the actual achievement value of the product characteristics from the relationship between the actual achievement value (benchmark value) of the product characteristics and the estimated value of customer satisfaction of the customer requirements. Hence, the user can determine how the customer satisfaction would change in accordance with the quality achievement level. Product evaluation at the upstream stage of design can be effectively executed. Hence, risk in actually putting the product on the market can be reduced. In addition, even when the values of product characteristics of a rival company are unknown, the estimated value of customer satisfaction by the company's achievement for our company is compared with the estimated value of customer satisfaction of the rival company. In this way, comparative evaluation with a rival company can be executed.

Furthermore, even when the estimated value of customer satisfaction of the customer requirements of another company is unknown, as far as the specifications of the product characteristics are known, the estimated value of customer satisfaction of the customer requirements can be estimated by applying the present invention using the specification of this company as actual achievement values.

The relationship between the actual achievement values of the product characteristics and the estimated values of customer satisfaction is obtained from functions shown in FIGS. 5 to 7. However, the relationship may be obtained based on another methods, such as a regression analysis method or a least square method.

As has been described above, according to the present invention, a method and program for obtaining useful evaluation information such as customer satisfaction from the achievement values of product characteristics by effectively using information of QFD can be provided.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, the present invention can also be implemented as a computer readable recording medium in which a program for allowing a computer to execute predetermined means, allowing the computer to function as predetermined means, or allowing the computer to realize a predetermined function is recorded.

What is claimed is:

1. A customer satisfaction evaluation method comprising:
obtaining data relating to a goal of customer requirements, a degree of association between the customer requirements and product characteristics, a baseline of the product characteristics, a target of the product characteristics based on a quality function development chart for converting the customer requirements to the product characteristics;
obtaining a relationship between the baseline of the product characteristics and the target of the product characteristics and a relationship between the goal of the customer requirements and a customer satisfaction of the customer requirements; and
obtaining a customer satisfaction of the customer requirements corresponding to an actual achievement value of the product characteristics.

2. The method according to claim 1, further comprising:
obtaining customer satisfactions of the customer requirements based on actual achievement values of product characteristics which are associated with the customer requirements; and
synthesizing the customer satisfactions to obtain a final customer satisfaction of the customer requirements.

3. The method according to claim 2, wherein said synthesizing comprises:
weighting the customer satisfactions based on degrees of association between the customer requirements and the product characteristics; and
adding the weighted customer satisfactions to obtain the final customer satisfaction.

4. The method according to claim 3, wherein said weighting comprises weighting only a part of the customer satisfactions that is selected based on a predetermined threshold.

5. The method according to claim 1, further comprising:
obtaining an index of achievement of the product characteristics based on the customer satisfaction.

6. The method according to claim 5, wherein the index of achievement includes a customer attitude rating defined by
$${\sum }_{i = 1}^{n} ( customer requirement importance rating ) i \times ( customer satisfaction of customer requirement ) i$$

7. The method according to claim 5, further comprising:
obtaining customer satisfactions for each of the customer requirements;
weighting the customer satisfactions based on the customer importance rating; and
adding the weighted customer satisfactions to obtain the index of achievement of the product characteristics.

8. The method according to claim 1, further comprising:
obtaining a customer satisfaction of the customer requirements corresponding to an actual achievement value of the product characteristics relating to a comparison object product.

9. An article of manufacture comprising a computer usable medium having computer readable program code means for evaluating a customer satisfaction embodied therein, the computer readable program code means comprising:
computer readable program code means for causing a computer to obtaining data relating to a goal of customer requirements, a degree of association between the customer requirements and product characteristics, a baseline of the product characteristics, a target of the product characteristics based on a quality function development chart for converting the customer requirements to the product characteristics;
computer readable program code means for causing a computer to obtain a relationship between the baseline of the product characteristics and the target of the product characteristics and a relationship between the goal of the customer requirements and a customer satisfaction of the customer requirements; and
computer readable program code means for causing a computer to obtain a customer satisfaction of the customer requirements corresponding to an actual achievement value of the product characteristics.

10. The article of manufacture according to claim 9, further comprising:
computer readable program code means for causing a computer to obtain customer satisfactions of the customer requirement based on actual achievement values of product characteristics which are associated with the customer requirements; and
computer readable program code means for causing a computer to synthesize the customer satisfactions to obtain a final customer satisfaction of the customer requirements.

11. The article of manufacture according to claim 10, wherein said synthesizing computer readable program code means comprises:
computer readable program code means for causing a computer to weight the customer satisfactions based on degrees of association between the customer requirements and the product characteristics; and
computer readable program code means for causing a computer to add the weighted customer satisfactions to obtain the final customer satisfaction.

12. The article of manufacture according to claim 11, wherein said weighting computer readable program code means comprises computer readable program code means for causing a computer to weight only a part of the customer satisfactions which is selected based on a predetermined threshold.

13. The article of manufacture according to claim 9, further comprising:
computer readable program code means for causing a computer to obtain an index of achievement of the product characteristics based on the customer satisfaction.

14. The article of manufacture according to claim 13, wherein the index of achievement includes a customer attitude rating defined by
$${\sum }_{i = 1}^{n} ( customer requirement importance rating ) i \times ( customer satisfaction of customer requirement ) i$$

15. The article of manufacture according to claim 14, further comprising:
computer readable program code means for causing a computer to obtain customer satisfactions for each of the customer requirements;
computer readable program code means for causing a computer to weight the customer satisfactions based on the customer importance rating; and
computer readable program code means for causing a computer to add the weighted customer satisfactions to obtain the index of achievement of the product characteristics.

16. The article of manufacture according to claim 9, further comprising:
computer readable program code means for causing a computer to obtain a customer satisfaction of the customer requirements corresponding to an actual achievement value of the product characteristics relating to a comparison object product.
